(19) United States
(12) Patent Application Publication
(10) Pub. No.: US 2025/0254363 A1
(43) Pub. Date: Aug. 7, 2025

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Yaojun WU, Beijing (CN); Semih ESENLIK, Los Angeles, CA (US); Zhaobin ZHANG, Los Angeles, CA (US); Meng WANG, Beijing (CN); Kai ZHANG, Los Angeles, CA (US); Li ZHANG, Los Angeles, CA (US)

(21) Appl. No.: 19/185,005

(22) Filed: Apr. 21, 2025

Related U.S. Application Data
(63) Continuation of application No. PCT/CN2023/125778, filed on Oct. 20, 2023.

(30) Foreign Application Priority Data
Oct. 21, 2022 (WO) PCT/CN2022/126683

(51) Int. Cl. H04N 19/70; G06V 10/82; H04N 19/124; H04N 19/59; H04N 19/91

(52) U.S. Cl. CPC H04N 19/70; G06V 10/82; H04N 19/124; H04N 19/59; H04N 19/91

(57) ABSTRACT

Embodiments of the present disclosure provide a solution for visual data processing. A method for visual data processing comprises: determining, for a conversion between a current visual unit of visual data and a bitstream of the visual data, precision information indicating at least one precise level for a plurality of modules, at least one of the plurality of modules being based on a neural network model; and performing the conversion by applying the plurality of modules to the current visual unit based on the precision information.

### CROSS REFERENCE TO RELATED APPLICATIONS

This application is a continuation of International Application No. PCT/CN2023/125778, filed on Oct. 20, 2023, which claims the benefit of International Application No. PCT/CN2022/126683 filed on Oct. 21, 2022. The entire contents of these applications are hereby incorporated by reference in their entireties.

### FIELDS

Embodiments of the present disclosure relates generally to visual data processing techniques, and more particularly, to precision information determination for processing module.

### BACKGROUND

Image/video compression is an essential technique to reduce the costs of image/video transmission and storage in a lossless or lossy manner. Image/video compression techniques can be divided into two branches, the classical video coding methods and the neural-network-based video compression methods. Classical video coding schemes adopt transform-based solutions, in which researchers have exploited statistical dependency in the latent variables (e.g., wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs. Coding efficiency of image/video coding is generally expected to be further improved.

### SUMMARY

Embodiments of the present disclosure provide a solution for visual data processing.

In a first aspect, a method for visual data processing is proposed. The method comprises: determining, for a conversion between a current visual unit of visual data and a bitstream of the visual data, precision information indicating at least one precise level for a plurality of modules, at least one of the plurality of modules being based on a neural network model; and performing the conversion by applying the plurality of modules to the current visual unit based on the precision information. The method in accordance with the first aspect of the present disclosure determines at least one precise level for the plurality of modules for the visual data processing. For example, a plurality of bit-depths or a single bit-depth may be determined for the plurality of modules. In this way, the plurality of modules can use proper precision level(s) to process the visual data. The coding efficiency and/or coding effectiveness can thus be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for data processing. The method comprises: determining precision information indicating at least one precise level for a plurality of modules, at least one of the plurality of modules being based on a neural network model; and generating the bitstream by applying the plurality of modules to a current video block of the visual data based on the precision information.

In a fifth aspect, a method for storing a bitstream of a video is proposed. The method comprises: determining precision information indicating at least one precise level for a plurality of modules, at least one of the plurality of modules being based on a neural network model; generating the bitstream by applying the plurality of modules to a current video block of the visual data based on the precision information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8 illustrates a flowchart of a method for visual data processing in accordance with embodiments of the present disclosure;

FIG. 9 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “visual data” may refer to image data or video data. The term “visual data processing” may refer to image processing or video processing. The term “visual data coding” may refer to image coding or video coding. The term “coding visual data” may refer to “encoding visual data (for example, encoding visual data into a bitstream)” and/or “decoding visual data (for example, decoding visual data from a bitstream”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

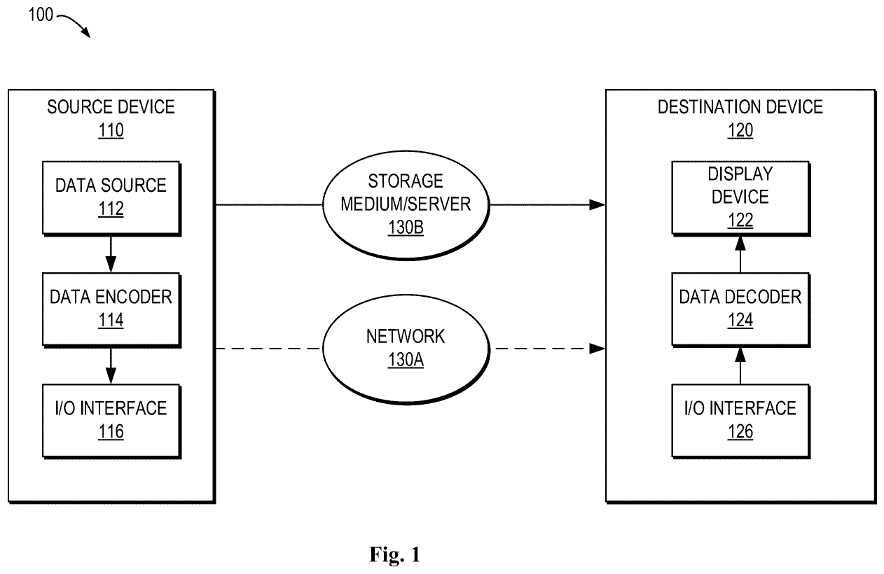

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a data encoding device or a visual data encoding device, and the destination device 120 can be also referred to as a data decoding device or a visual data decoding device. In operation, the source device 110 can be configured to generate encoded visual data and the destination device 120 can be configured to decode the encoded visual data generated by the source device 110. The source device 110 may include a data source 112, a data encoder 114, and an input/output (I/O) interface 116.

The data source 112 may include a source such as a data capture device. Examples of the data capture device include, but are not limited to, an interface to receive data from a data provider, a computer graphics system for generating data, and/or a combination thereof.

The data may comprise one or more pictures of a video or one or more images. The data encoder 114 encodes the data from the data source 112 to generate a bitstream. The bitstream may include a sequence of bits that form a coded representation of the data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded data may be transmitted directly to destination device 120 via the I/O interface 116 through the network 130A. The encoded data may also be stored onto a storage medium/server 130B for access by destination device 120.

The destination device 120 may include an I/O interface 126, a data decoder 124, and a display device 122. The I/O interface 126 may include a receiver and/or a modem. The I/O interface 126 may acquire encoded data from the source device 110 or the storage medium/server 130B. The data decoder 124 may decode the encoded data. The display device 122 may display the decoded data to a user. The display device 122 may be integrated with the destination device 120, or may be external to the destination device 120 which is configured to interface with an external display device.

The data encoder 114 and the data decoder 124 may operate according to a data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific data codecs, the disclosed techniques are applicable to other coding technologies also. Furthermore, while some embodiments describe coding steps in detail, it will be understood that corresponding steps decoding that undo the coding will be implemented by a decoder. Furthermore, the term data processing encompasses data coding or compression, data decoding or decompression and data transcoding in which data are represented from one compressed format into another compressed format or at a different compressed bitrate.

### 1. Brief summary

This disclosure is related to a neural network-based image and video compression approach utilizing an auto-regressive neural network. The disclosure targets the problem of precision setting of the component inside the learned image and video compression method, to speed up the encoding and decoding time, and solving the issue that may cause by the limitation of the devices.

### 2. Introduction

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression.

However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks For Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as—log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit—log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based previous observations, where x is an image, can be expressed as follows:

$$p ( x ) = p ( {x}_{1} ) p ( {x}_{1} \vert {x}_{2} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult.

Thereby, a simplified d is t limit the range of the context of the current pixel as follows:

$$p ( x ) = p ( {x}_{1} ) p ( {x}_{1} \vert {x}_{2} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration.

For example, when coding the red (R), green (G), and blue (B) (RGB) color component, the R sample is dependent on previously coded pixels (including R, G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁,x₂, . . . , xᵢ₋₁. In an example neural network design, the pixel probability is employed for binary images according to xᵢ ∈{—1,+1}. The neural autoregressive distribution estimator (NADE) is designed for pixel probability modeling. NADE is a feed-forward network with a single hidden layer. In another example, the feed-forward network may include connections skipping the hidden layer. Further, the parameters may also be shared. In an example, experiments can be performed on a binarized MNIST dataset. In an example, NADE is extended to a real-valued NADE (RNADE) model, where the probability p(xᵢ|x₁, . . . , xᵢ₋₁) is derived with a mixture of Gaussians. The RNADE model feed-forward network also has a single hidden layer, but the hidden layer employs rescaling to avoid saturation and uses a rectified linear unit (ReLU) instead of sigmoid. In another example, NADE and RNADE are improved by using reorganizing the order of the pixels and with deeper neural networks.

Designing advanced neural networks plays an important role in improving pixel probability modeling. In an example neural network, a multi-dimensional long short-term memory (LSTM) is used. The LSTM works together with mixtures of conditional Gaussian scale mixtures for probability modeling. LSTM is a special kind of recurrent neural networks (RNNs) and may be employed to model sequential data. The spatial variant of LSTM may also be used for images later. Several different neural networks may be employed, including recurrent neural networks (RNNs) and convolutional neural networks (CNNs), such as Pixel RNN (PixelRNN) and Pixel CNN (PixelCNN), respectively. In PixelRNN, two variants of LSTM, denoted as row LSTM and diagonal bidirectional LSTM (BiLSTM) are employed. Diagonal BiLSTM is specifically designed for images. PixelRNN incorporates residual connections to help train deep neural networks with up to twelve layers. In PixelCNN, masked convolutions are used to adjust for the shape of the context. PixelRNN and PixelCNN are more dedicated to natural images. For example, PixelRNN and PixelCNN consider pixels as discrete values (e.g., 0, 1, . . . , 255) and predict a multinomial distribution over the discrete values. Further, PixelRNN and PixelCNN deal with color images in RGB color space. In addition, PixelRNN and PixelCNN work well on the large-scale image dataset image network (ImageNet). In an example, a Gated PixelCNN is used to improve the PixelCNN. Gated PixelCNN achieves comparable performance with PixelRNN, but with much less complexity. In an example, a PixelCNN++ is employed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; and RGB is combined for one pixel. In another example, PixelSNAIL combines casual convolutions with self-attention.

Most of the above methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

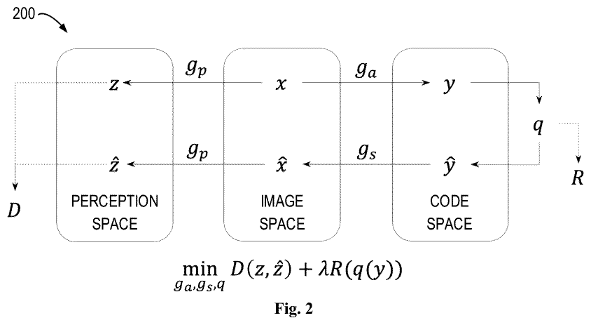

FIG. 2 is a schematic diagram illustrating an example transform coding scheme 200. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network g, to obtain the reconstructed image x. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme 200 can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image x=gₛ(ŷ). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

In terms of network structure, RNNs and CNNs are the most widely used architectures. In the RNNs relevant category, an example general framework for variable rate image compression uses RNN. The example uses binary quantization to generate codes and does not consider rate during training. The framework provides a scalable coding functionality, where RNN with convolutional and deconvolution layers performs well. Another example offers an improved version by upgrading the encoder with a neural network similar to PixelRNN to compress the binary codes. The performance is better than JPEG on a Kodak image dataset using multi-scale structural similarity (MS-SSIM) evaluation metric. Another example further improves the RNN-based solution by introducing hidden-state priming. In addition, an SSIM-weighted loss function is also designed, and a spatially adaptive bitrates mechanism is included. This example achieves better results than better portable graphics (BPG) on the Kodak image dataset using MS-SSIM as evaluation metric. Another example system supports spatially adaptive bitrates by training stop-code tolerant RNNs.

Another example proposes a general framework for rate-distortion optimized image compression. The example system uses multiary quantization to generate integer codes and considers the rate during training. The loss is the joint rate-distortion cost, which can be mean square error (MSE) or other metrics. The example system adds random uniform noise to stimulate the quantization during training and uses the differential entropy of the noisy codes as a proxy for the rate. The example system uses generalized divisive normalization (GDN) as the network structure, which includes a linear mapping followed by a nonlinear parametric normalization. The effectiveness of GDN on image coding is verified. Another example system includes improved version that uses three convolutional layers each followed by a down-sampling layer and a GDN layer as the forward transform. Accordingly, this example version uses three layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Another example improves the method by devising a scale hyper-prior into the auto-encoder. The system transforms the latent representation y with a subnet hₐ to z=hₐ(y) and z is quantized and transmitted as side information. Accordingly, the inverse transform is implemented with a subnet h, that decodes from the quantized side information x to the standard deviation of the quantized ŷ, which is further used during the arithmetic coding of ŷ. On the Kodak image set, this method is slightly worse than BGP in terms of peak signal to noise ratio (PSNR). Another example system further exploits the structures in the residue space by introducing an autoregressive model to estimate both the standard deviation and the mean. This example uses a Gaussian mixture model to further remove redundancy in the residue. The performance is on par with VVC on the Kodak image set using PSNR as evaluation metric.

### 2.3.3 Hyper Prior Model

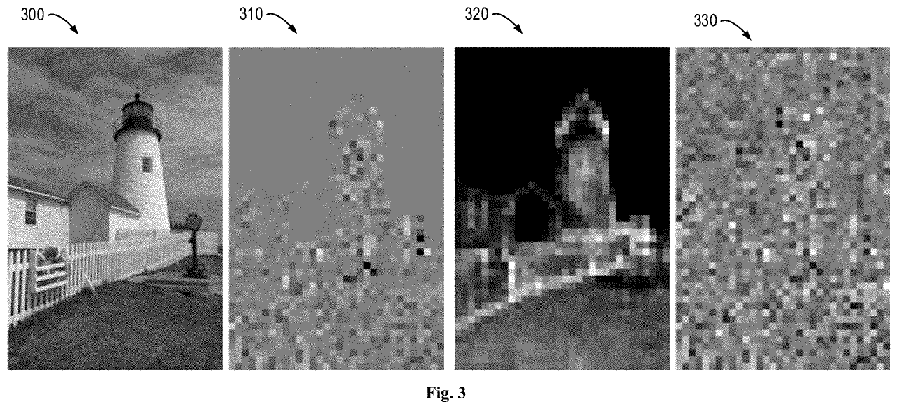

FIG. 3 illustrates example latent representations of an image, including an image 300 from the Kodak dataset, a visualization of the latent 310 representation y of the image 300, a standard deviations a 320 of the latent 310, and latents y 330 after a hyper prior network is introduced. A hyper prior network includes a hyper encoder and decoder. In the transform coding approach to image compression, as shown in FIG. 2, the encoder subnetwork transforms the image vector x using a parametric analysis transform gₐ(x,Θ_{g}) into a latent representation y, which is then quantized to form ŷ. Because ŷ is discrete-valued, ŷ can be losslessly compressed using entropy coding techniques such as arithmetic coding and transmitted as a sequence of bits.

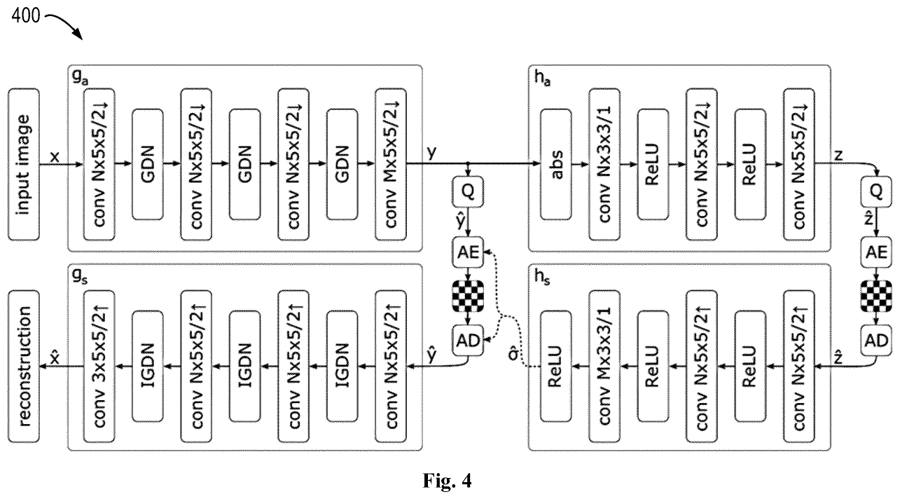

As evident from the latent 310 and the standard deviations a 320 of FIG. 3, there are significant spatial dependencies among the elements of ŷ. Notably, their scales (standard deviations a 320) appear to be coupled spatially. An additional set of random variables \hat{z} may be introduced to capture the spatial dependencies and to further reduce the redundancies. In this case the image compression network is depicted in FIG. 4.

FIG. 4 is a schematic diagram 400 illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram 400, the upper side of the models is the encoder gₐ and decoder gₛ as discussed above. The lower side is the additional hyper encoder hₐ and hyper decoder h, networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector z to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 330 in FIG. 3 correspond to the quantized latent when the hyper encoder/decoder are used. Compared to the standard deviations σ 320, the spatial redundancies are significantly reduced as the samples of the quantized latent are less correlated.

### 2.3.4 Context Model

Although the hyperprior model improves the modelling of the probability distribution of the quantized latent f, additional improvement can be obtained by utilizing an autoregressive model that predicts quantized latents from their causal context, which may be known as a context model.

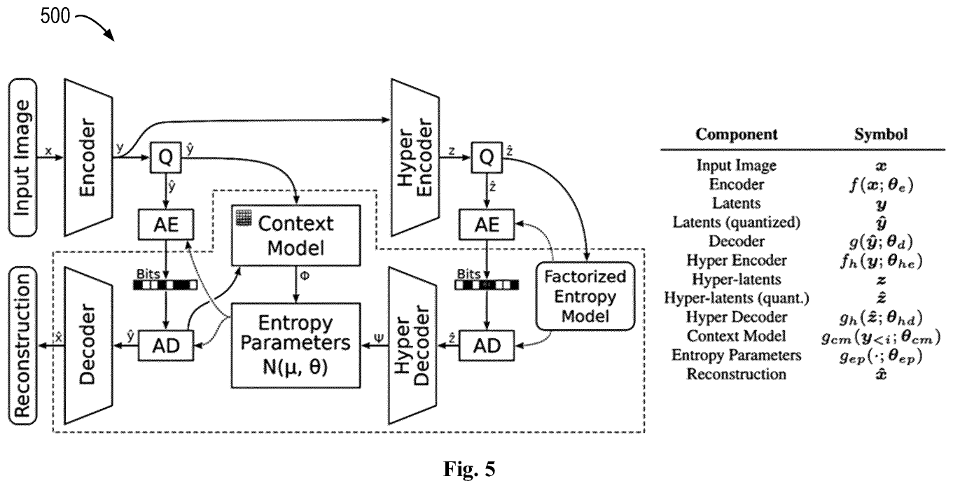

The term auto-regressive indicates that the output of a process is later used as an input to the process. For example, the context model subnetwork generates one sample of a latent, which is later used as input to obtain the next sample. FIG. 5 is a schematic diagram 500 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g., a decoder) to recover an image from a compressed bitstream.

An example system utilizes a joint architecture where both a hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in schematic diagram 500, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the schematic diagram 500, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 the Encoding Process Using Joint Auto-Regressive Hyper Prior Model

The design in FIG. 5. corresponds an example combined compression method. In this section and the next, the encoding and decoding processes are described separately.

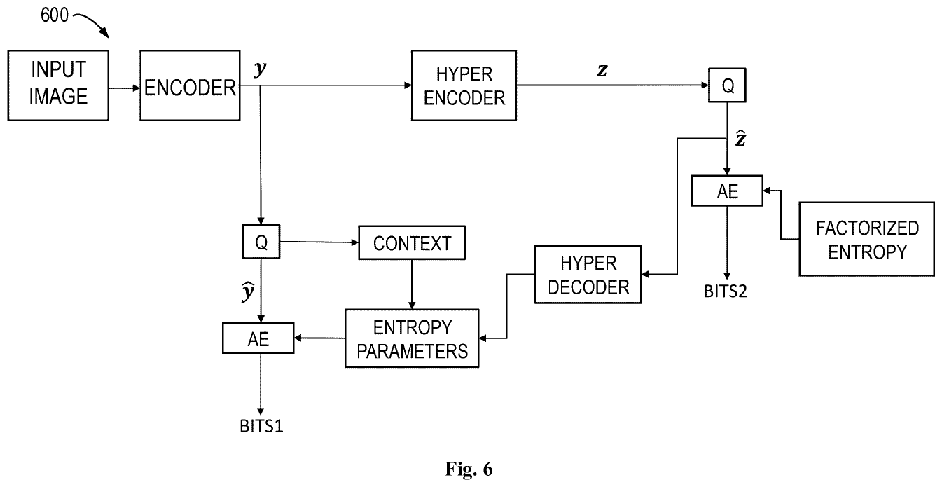

FIG. 6 illustrates an example encoding process 600. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the y into a bitstream (bits1) one by one, in a sequential order.

The modules hyper encoder, context, hyper decoder, and entropy parameters subnetworks are used to estimate the probability distributions of the samples of the quantized latent ŷ, the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module is used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 6 are collectively called an encoder. The analysis transform that converts the input image into latent representation is also called an encoder (or auto-encoder).

### 2.3.6 the Decoding Process Using Joint Auto-Regressive Hyper Prior Model

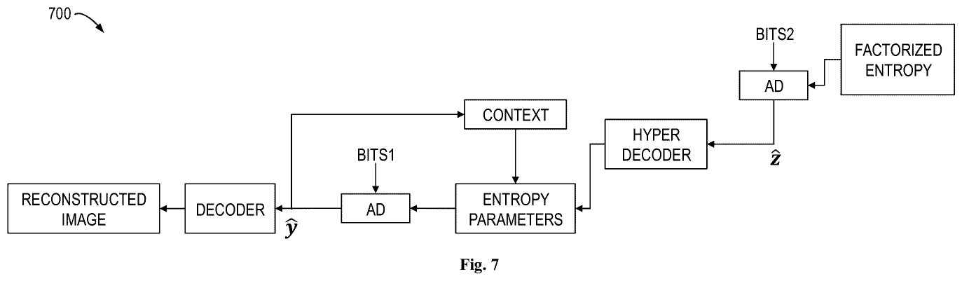

FIG. 7 illustrates an example decoding process 700. FIG. 7 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.4.1 Low-latency

An example system employs a video compression scheme with trained neural networks. The system first splits the video sequence frames into blocks and each block is coded according to an intra coding mode or an inter coding mode. If intra coding is selected, there is an associated auto-encoder to compress the block. If inter coding is selected, motion estimation and compensation are performed and a trained neural network is used for residue compression. The outputs of auto-encoders are directly quantized and coded by the Huffman method.

Another neural network-based video coding scheme employs PixelMotionCNN. The frames are compressed in the temporal order, and each frame is split into blocks which are compressed in the raster scan order. Each frame is first extrapolated with the preceding two reconstructed frames. When a block is to be compressed, the extrapolated frame along with the context of the current block are fed into the PixelMotionCNN to derive a latent representation. Then the residues are compressed by a variable rate image scheme. This scheme performs on par with H.264.

Another example system employs an end-to-end neural network-based video compression framework, in which all the modules are implemented with neural networks. The scheme accepts a current frame and a prior reconstructed frame as inputs. An optical flow is derived with a pre-trained neural network as the motion information. The motion information is warped with the reference frame followed by a neural network generating the motion compensated frame. The residues and the motion information are compressed with two separate neural auto-encoders. The whole framework is trained with a single rate-distortion loss function. The example system achieves better performance than H.264.

Another example system employs an advanced neural network-based video compression scheme. The system inherits and extends video coding schemes with neural networks with the following major features. First the system uses only one auto-encoder to compress motion information and residues. Second, the system uses motion compensation with multiple frames and multiple optical flows. Third, the system uses an on-line state that is learned and propagated through the following frames over time. This scheme achieves better performance in MS-SSIM than HEVC reference software.

Another example system uses an extended end-to-end neural network-based video compression framework. In this example, multiple frames are used as references. The example system is thereby able to provide more accurate prediction of a current frame by using multiple reference frames and associated motion information. In addition, a motion field prediction is deployed to remove motion redundancy along temporal channel. Postprocessing networks are also used to remove reconstruction artifacts from previous processes. The performance of this system is better than H.265 by a noticeable margin in terms of both PSNR and MS-SSIM.

Another example system uses scale-space flow to replace an optical flow by adding a scale parameter based on a framework. This example system may achieve better performance than H.264. Another example system uses a multi-resolution representation for optical flows based. Concretely, the motion estimation network produces multiple optical flows with different resolutions and let the network learn which one to choose under the loss function. The performance is slightly better than H.265.

### 2.4.2 Random Access

Another example system uses a neural network-based video compression scheme with frame interpolation. The key frames are first compressed with a neural image compressor and the remaining frames are compressed in a hierarchical order. The system performs motion compensation in the perceptual domain by deriving the feature maps at multiple spatial scales of the original frame and using motion to warp the feature maps. The results are used for the image compressor. The method is on par with H.264.

An example system uses a method for interpolation-based video compression. The interpolation model combines motion information compression and image synthesis. The same auto-encoder is used for image and residual. Another example system employs a neural network-based video compression method based on variational auto-encoders with a deterministic encoder. Concretely, the model includes an auto-encoder and an auto-regressive prior. Different from previous methods, this system accepts a group of pictures (GOP) as inputs and incorporates a three dimensional (3D) autoregressive prior by taking into account of the temporal correlation while coding the latent representations. This system provides comparative performance as H.265.

### 2.5 Preliminaries

Almost all the natural image and/or video is in digital format. A grayscale digital image can be represented by x ∈ [symbol] ^{m×n} where [symbol] is the set of values of a pixel, m is the image height, and n is the image width. For example, [symbol] ={0,1,2, . . . ,255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x ∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference choma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . ,xₜ, . . . ,x_{T-1}} where T is the number of frames in a video sequence and x ∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max ( [symbol] ) is the maximal value in [symbol] e.g., 255 for 8-bit grayscale images. There are other quality evaluation metrics such as structural similarity (SSIM) and multi-scale SSIM (MS-SSIM).

To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 3. Technical Problems Solved by Disclosed Technical Solutions

Example learned image and video compression networks achieve great compression compared with codecs. In some designs, the precision of the network is fixed high precision, which may lead to following issues:
1) For some cases, high precision on the network is not necessary. Lower precision network can achieve similar performance. Fixed precision not only did not provide additional gains, but also brings a lot of time overhead and waste of computing resources.
2) For device with limit computation resources, maintain fix precision may bring issues such as out of the memory or long latency in coding phase.
3) With the increasing demands for high resolution image, out of the memory issues may be common for solution using full image as the input of the network, reduction on network computation is mandatory.
4) For high bits inputs (10bits, 12bits, etc.), higher precision is important to preserve the pixel level fidelity as much as possible.

To meets different requirement in practical compression, adaptive solutions to the precision of the learned image and video compression method is useful.

### 4. Detailed Solutions

To solve the above problems and some other problems not mentioned, methods, as summarized below, are disclosed.

The disclosed items should be considered as examples to explain the general concepts and should not be interpreted narrowly. Furthermore, these aspects can be applied individually or combined in any manner.

The techniques described herein provide solutions to adaptively select different precision of the network to meets the requirement of different scenarios. Specifically, the aspects include the following examples:
1) To solve problem 1, one syntax elements may be signaled in the image or video message, all modules that inside the compression network utilize the same precision that indicate by a same syntax precision_all.
   a. In one example, the precision choice set of the network might be {int8, int16, int32, int64, float 8, float16, float32, float64}.
   b. In one example, the precision choice set of the network might be a subset of the set that used in example 1) a.
   c. In one example, other possible potential precision choices might be included into the precision choice set.
   d. In one example, to adaptively select the best precision_all, one image will be tested on multiple times, and the best precision_all will be obtained and based on the compression ratio, maximum memory during the compression, and multiply-accumulate operation (MAC).
   e. In one example, the precision_all will be a fixed parameter that predefined based on the characteristics of the scenario.
      i. In one example, the parameter may be determined by the resolution of the input image.
      ii. In one example, the parameter may be determined by the bit-depth of the input
      iii. In one example, the parameter may be determined by the content of the input (e.g. surveillance, screen content, natural scene).
2) In one example, multi syntax elements may be signaled in the image or video message, different module will use different precisions based on the syntax precision_submodule_x, where x is a numerical number that used to indicator one or some of the submodules.
   a. In one example, based on the type of the operation (convolution, activation), different operation will be classified into different submodules, and then processed with different precision.
   b. Alternatively, based on the functionality of the modules inside codec (inference, synthesis, entropy coding, quantization etc.), different functions may be processed with different precision.
   c. In one example, the precision choice set of the network might be {int8, int16, int32, int64, float 8, float16, float32, float64}.
   d. In one example, the precision choice set of the network might be a subset of the set that used in example 1) a.
   e. In one example, other possible potential precision choices might be included into the precision choice set.
   f. In one example, to adaptively select the best precision_submodule_x, one image will be tested on multiple times, and the best precision_submodule_x will be obtained and based on the compression ratio, maximum memory during the compression, and multiply-accumulate operation (MAC).
   g. In one example, to adaptively select the setting of the precision_submodule_x, neural architecture search will be utilized.
   h. In one example, the precision_submodule_x will be a fixed parameter that predefined based on the characteristics of the scenario.
      i. In one example, the parameter may be determined by the resolution of the input image.
      ii. In one example, the parameter may be determined by the bit-depth of the input.
      iii. In one example, the parameter may be determined by the content of the input (e.g. surveillance, screen content, natural scene).
3) In one example, the basic unit for the setting of the network precision might be tile or full image.
   a. In one example, to code the precision information that used in each basic unit, precision information can be compressed with entropy coding tools.
   b. Alternatively, the precision information will be obtained/predicted based on the previous coded tiles.
4) In one example, to support the precision changing between modules, mixed precision calculation will be performed.
   a. In one example, automatically mixed precision calculation will be performed.
5) In one example, the setting of the precision can be stored in a profile or level setting.
6) In one example, between two adjacent operations of different precision, quantization and inverse quantization may be performed to reduce errors that caused by precision switching.
   a. In one example, the quantization and inverse quantization operation can be learned though training dataset.
   b. Alternatively, the factor of the quantization and inversion quantization can be obtained through the encoder, and then be transmitted in the bitstream.

### 5. Embodiments

1. An image decoding method, comprising the steps of:
Obtaining, using the information from bitstream, the bit-depth information for all submodules in decoding model.
Based on the bit-depth information, initialize all submodules with their corresponding precisions.
Obtaining, the quantized latent by using the entropy model.
Obtaining, the reconstruction according to the decoded quantized latent and synthesis models.

2. An image encoding method, comprising the steps of:
Obtaining, according to the adaptive selection, the bit-depth information for all modules.
Obtaining a latent sample using an analysis transform.
Obtaining the quantized latent by using the scaling and round operation.
Obtaining the bitstream of latent by using the entropy coding module.
Encode necessary high-level syntax and add them on the latest bitstream.

3. According to claim 1 or 2, bit-depth information can be a profile/level indicator, which will be selected based on the usage of the encoding/decoding scenario.

4. According to all claims above, automatic Mixed precision is used to support the precision changing between related submodules.

5. According to claim 3, the adaptive selection of the profile/level indicator will based on the resolution and bit-depth of the input image, also latency will be considered.

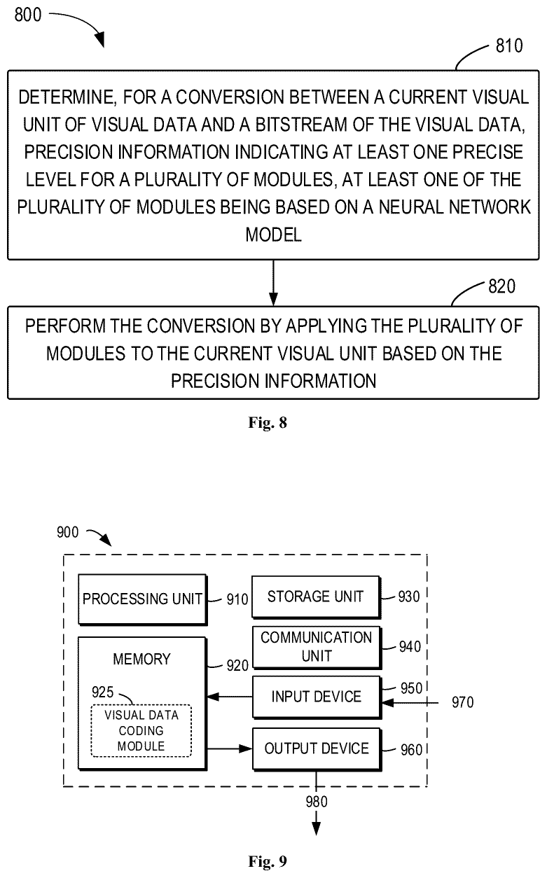

FIG. 8 illustrates a flowchart of a method 800 for visual data processing in accordance with embodiments of the present disclosure. The method 800 is implemented for a conversion between a current visual unit of visual data and a bitstream of the visual data.

At block 810, precision information indicating at least one precise level for a plurality of modules is determined. At least one of the plurality of modules is based on a neural network model. For example, the plurality of modules may be a plurality of neural network model-based modules, such as one or more modules in FIG. 7. At block 820, the conversion is performed by applying the plurality of modules to the current visual unit based on the precision information.

The method 800 enables determining the at least one precision level for the plurality of modules. The conversion thus can be performed by using the plurality of modules based on respective precision levels of the plurality of modules. In this way, the plurality of modules can operate with proper precision level(s).

The coding effectiveness and/or coding efficiency can thus be improved.

In some embodiments, the precision information is determined based on a plurality of syntax elements in the bitstream, a syntax element of the plurality of syntax elements indicates a precision level for at least one module of the plurality of modules. For example, multiple syntax elements may be signaled in the image or video message. Different modules may use different precisions based on the syntax element such as precision_submodule_x, where x is a numerical number that used to indicate a precision level (also referred to as a precision) such as a bit-depth.

In some embodiments, the method 800 further comprises: determining a precision level from the plurality of precision levels for a first module of the plurality of modules based on a functionality of the first module. For example, based on the functionality of the modules inside a coder such as codec, different functionalities may be processed with different precisions.

In some embodiments, the functionality of the first module comprises one of: an inference functionality, a synthesis functionality, an entropy coding functionality, or a quantization functionality.

In some embodiments, a first precision level from the plurality of precision levels is associated with a first functionality, and a second precision level from the plurality of precision levels is associated with a second functionality.

In some embodiments, the method 800 further comprises: determining a precision level from the plurality of precision levels for a first module of the plurality of modules based on an operation type of the first module. For example, based on the type of the operation, different operations may be classified into different modules or submodules, and then be processed with different precisions.

In some embodiments, the operation type of the first module comprises one of: a convolutional operation, or an activation operation.

In some embodiments, the plurality of precision levels comprises at least one of: int8, int16, int32, int64, float8, float16, float32, float64, or a further precision level. For example, the precision choice set of the coder such as a network for visual processing may be {int8, int16, int32, int64, float8, float16, float32, float64}. The precision choice set may be a subset of the above example set. Alternatively, the precision choice set may include other possible potential precision choice. The plurality of precision levels may be from the precision choice set. For example, the syntax element precision_submodule_x may be an index of a selected precision level in the precision choice set. If multiple syntax elements precision_submodule_x is included in the bitstream, the precision information may indicate multiple precision levels selected from the precision choice set based on the multiple syntax elements precision_submodule_x (that is, multiple indices for precision levels in the precision choice set).

In some embodiments, the precision information is based on a single syntax element in the bitstream, the single syntax element indicating a single precision level for the plurality of modules. For example, one syntax element may be signaled in the image or video message. All modules in the coder or in the compression network may use the same precision level indicated by the same syntax element such as precision_all.

In some embodiments, the single precision level comprises one of: int8, int16, int32, int64, float8, float16, float32, float64, or a further precision level. For example, the single precision level may be from the precision choice set, such as {int8, int16, int32, int64, float8, float16, float32, float64}. The precision choice set may be a subset of the above example set. Alternatively, the precision choice set may include other possible potential precision choice. The single precision level may be selected from the precision choice set for example based on the syntax element precision_all. In such cases, the precision_all may be an index of the single precision level in the precision choice set.

In some embodiments, the at least one precision level is determined based on a result of at least one testing compression of the visual data. By way of example, the result comprises at least one of: a compression ratio of the visual data, a maximum memory during the at least one testing compression, or a multiply-accumulate operation. For example, to adaptively select a precision_submodule_x or precision_all, an image may be tested on multiple times, and the precision_submodule_x or precision_all may be obtained and based on the compression ratio, maximum memory during the compression, and multiply-accumulate operation (MAC).

In some embodiments, the at least one precision level is determined based on a neural architecture search. For example, to adaptively select a precision_submodule_x or precision_all, neural architecture search may be utilized.

In some embodiments, the at least one precision level is determined based on a characteristic of a scenario of the visual data. For example, the precision_submodule_x or precision_all may be a fixed parameter that is predefined based on the characteristics of the scenario. The characteristic may include at least one of: a resolution of the visual data such as the input image, a bit-depth of the visual data such as the input, or a content of the visual data. By way of example, the content of the visual data comprises at least one of: a surveillance content, a screen content. or a natural scene.

In some embodiments, the visual data comprises an image or a video, and the current visual unit comprises one of: a tile, the image, or an image in the video. As used herein, an image in the video may also be referred to as a picture in the video. For example, the basic unit for the setting of the network precision may be tile or full image.

In some embodiments, the precision information is compressed with an entropy coding tool. That is, to code the precision information used in each basic unit, precision information may be compressed with entropy coding tools.

In some embodiments, the precision information is determined based on further precision information of a further visual unit previously coded. For example, the precision information may be obtained or predicted based on previous coded tiles.

In some embodiments, a mixed precision determination is performed during the conversion. For example, to support the precision changing between modules, mixed precision calculation such as automatically mixed precision calculation may be performed.

In some embodiments, the precision information is stored in at least one of: a profile associated with the visual data, or a level setting associated with the visual data. That is, the setting of the precision may be stored in a profile or level setting. For example, bit-depth information may be a profile or a level indicator indicating the precision information or the at least one precision level, which may be selected based on the usage of the encoding or decoding scenario. The adaptive selection of the profile or level indicator may be based on the resolution and bit-depth of the input image, and optionally the latency may be considered.

In some embodiments, a first operation is adjacent to a second operation during the conversion, the first operation being associated with a first precision level, the second operation being associated with a second precision level different from the first precision level, and wherein performing the conversion comprises: performing the first operation to a first representation associated with the visual data to obtain a second representation; performing at least one of a quantization operation or an inverse quantization operation to the second representation to obtain a third representation; and performing the second operation to the third representation. That is, between two adjacent operations of different precisions, quantization and inverse quantization may be performed to reduce errors caused by precision switching.

In some embodiments, at least one of a first parameter of the quantization operation or a second parameter of the inverse quantization operation is determined based on a training dataset. For example, the quantization and inverse quantization operation may be learned through training dataset.

In some embodiments, at least one of a first parameter of the quantization operation or a second parameter of the inverse quantization operation is included in the bitstream. For example, the factor of the quantization and inverse quantization may be obtained through the encoder, and then be transmitted in the bitstream.

In some embodiments, at least one of the first parameter or the second parameter is determined by an encoder for encoding the current visual unit into the bitstream.

In some embodiments, the conversion comprises decoding the current visual unit from the bitstream.

In some embodiments, the plurality of modules at least comprises an entropy module, a decoding module and a synthesis module, the precision information is obtained from at least one syntax element in the bitstream, and wherein performing the conversion comprises: determining respective precision levels of the plurality of modules based on the precision information; initializing the plurality of modules based on the respective precision levels; determining a first representation of the current visual unit based on the bitstream by using the entropy module; determining a second representation of the current visual unit based on the first representation by using the decoding module; and determining a reconstruction of the current visual unit based on the second representation by using the synthesis module.

In some embodiments, the conversion comprises encoding the current visual unit into the bitstream.

In some embodiments, the method 800 further comprises: determining at least one precision level for the plurality of modules based on at least one of: operation types of the plurality of modules, functionalities of the plurality of modules, a result of at least one testing compression of the visual data, a neural architecture search, or a characteristic of a scenario of the visual data; determining a first representation of the at least one precision level based on an analysis transform; determining a second representation of the at least one precision level based on the first representation by using at least one of a scaling operation or a rounding operation; determining at least one syntax element for the precision information based on the second representation and an entropy coding module; and including the at least one syntax element in the bitstream.

According to further embodiments of the present disclosure, a non-transitory computer-readable recording medium is provided. The non-transitory computer-readable recording medium stores a bitstream of visual data which is generated by a method performed by an apparatus for visual data processing. In the method, precision information indicating at least one precise level for a plurality of modules is determined.

At least one of the plurality of modules is based on a neural network model. The bitstream is generated by applying the plurality of modules to a current visual unit of the visual data based on the precision information.

According to still further embodiments of the present disclosure, a method for storing bitstream of a video is provided. In the method, precision information indicating at least one precise level for a plurality of modules is determined. At least one of the plurality of modules is based on a neural network model. The bitstream is generated by applying the plurality of modules to a current visual unit of the visual data based on the precision information. The bitstream is stored in a non-transitory computer-readable recording medium.

Implementations of the present disclosure can be described in view of the following clauses, the features of which can be combined in any reasonable manner.

Clause 1. A method for visual data processing, comprising: determining, for a conversion between a current visual unit of visual data and a bitstream of the visual data, precision information indicating at least one precise level for a plurality of modules, at least one of the plurality of modules being based on a neural network model; and performing the conversion by applying the plurality of modules to the current visual unit based on the precision information.

Clause 2. The method of clause 1, wherein the precision information is determined based on a plurality of syntax elements in the bitstream, a syntax element of the plurality of syntax elements indicates a precision level for at least one module of the plurality of modules.

Clause 3. The method of clause 2, further comprising: determining a precision level from the plurality of precision levels for a first module of the plurality of modules based on a functionality of the first module.

Clause 4. The method of clause 3, wherein the functionality of the first module comprises one of: an inference functionality, a synthesis functionality, an entropy coding functionality, or a quantization functionality.

Clause 5. The method of clause 3 or clause 4, wherein a first precision level from the plurality of precision levels is associated with a first functionality, and a second precision level from the plurality of precision levels is associated with a second functionality.

Clause 6. The method of clause 2, further comprising: determining a precision level from the plurality of precision levels for a first module of the plurality of modules based on an operation type of the first module.

Clause 7. The method of clause 6, wherein the operation type of the first module comprises one of: a convolutional operation, or an activation operation.

Clause 8. The method of any of clauses 2-5, wherein the plurality of precision levels comprises at least one of: int8, int16, int32, int64, float8, float16, float32, float64, or a further precision level.

Clause 9. The method of clause 1, wherein the precision information is based on a single syntax element in the bitstream, the single syntax element indicating a single precision level for the plurality of modules.

Clause 10. The method of clause 9, wherein the single precision level comprises one of: int8, int16, int32, int64, float8, float16, float32, float64, or a further precision level.

Clause 11. The method of any of clauses 1-10, wherein the at least one precision level is determined based on a result of at least one testing compression of the visual data.

Clause 12. The method of clause 11, wherein the result comprises at least one of: a compression ratio of the visual data, a maximum memory during the at least one testing compression, or a multiply-accumulate operation.

Clause 13. The method of any of clauses 1-10, wherein the at least one precision level is determined based on a neural architecture search.

Clause 14. The method of any of clauses 1-10, wherein the at least one precision level is determined based on a characteristic of a scenario of the visual data.

Clause 15. The method of clause 14, wherein the characteristic comprises at least one of: a resolution of the visual data, a bit-depth of the visual data, or a content of the visual data.

Clause 16. The method of clause 15, wherein the content of the visual data comprises at least one of: a surveillance content, a screen content. or a natural scene.

Clause 17. The method of any of clauses 1-16, wherein the visual data comprises an image or a video, and the current visual unit comprises one of: a tile, the image, or an image in the video.

Clause 18. The method of any of clauses 1-17, wherein the precision information is compressed with an entropy coding tool.

Clause 19. The method of any of clauses 1-18, wherein the precision information is determined based on further precision information of a further visual unit previously coded.

Clause 20. The method of any of clauses 1-19, wherein a mixed precision determination is performed during the conversion.

Clause 21. The method of any of clauses 1-20, wherein the precision information is stored in at least one of: a profile associated with the visual data, or a level setting associated with the visual data.

Clause 22. The method of any of clauses 1-21, wherein a first operation is adjacent to a second operation during the conversion, the first operation being associated with a first precision level, the second operation being associated with a second precision level different from the first precision level, and wherein performing the conversion comprises: performing the first operation to a first representation associated with the visual data to obtain a second representation; performing at least one of a quantization operation or an inverse quantization operation to the second representation to obtain a third representation; and performing the second operation to the third representation.

Clause 23. The method of clause 22, wherein at least one of a first parameter of the quantization operation or a second parameter of the inverse quantization operation is determined based on a training dataset.

Clause 24. The method of clause 22, wherein at least one of a first parameter of the quantization operation or a second parameter of the inverse quantization operation is included in the bitstream.

Clause 25. The method of clause 24, wherein at least one of the first parameter or the second parameter is determined by an encoder for encoding the current visual unit into the bitstream.

Clause 26. The method of clause 1, wherein the conversion comprises decoding the current visual unit from the bitstream.

Clause 27. The method of clause 26, wherein the plurality of modules at least comprises an entropy module, a decoding module and a synthesis module, the precision information is obtained from at least one syntax element in the bitstream, and wherein performing the conversion comprises: determining respective precision levels of the plurality of modules based on the precision information; initializing the plurality of modules based on the respective precision levels; determining a first representation of the current visual unit based on the bitstream by using the entropy module; determining a second representation of the current visual unit based on the first representation by using the decoding module; and determining a reconstruction of the current visual unit based on the second representation by using the synthesis module.

Clause 28. The method of clause 1, wherein the conversion comprises encoding the current visual unit into the bitstream.

Clause 29. The method of clause 28, further comprising: determining at least one precision level for the plurality of modules based on at least one of: operation types of the plurality of modules, functionalities of the plurality of modules, a result of at least one testing compression of the visual data, a neural architecture search, or a characteristic of a scenario of the visual data; determining a first representation of the at least one precision level based on an analysis transform; determining a second representation of the at least one precision level based on the first representation by using at least one of a scaling operation or a rounding operation; determining at least one syntax element for the precision information based on the second representation and an entropy coding module; and including the at least one syntax element in the bitstream.

Clause 30. An apparatus for visual data processing comprising a processor and a non-transitory memory with instructions thereon, wherein the instructions upon execution by the processor, cause the processor to perform a method in accordance with any of clauses 1-29.

Clause 31. A non-transitory computer-readable storage medium storing instructions that cause a processor to perform a method in accordance with any of clauses 1-29.

Clause 32. A non-transitory computer-readable recording medium storing a bitstream of a video which is generated by a method performed by an apparatus for data processing, wherein the method comprises: determining precision information indicating at least one precise level for a plurality of modules, at least one of the plurality of modules being based on a neural network model; and generating the bitstream by applying the plurality of modules to a current visual unit of the visual data based on the precision information.

Clause 33. A method for storing a bitstream of a video, comprising: determining precision information indicating at least one precise level for a plurality of modules, at least one of the plurality of modules being based on a neural network model; generating the bitstream by applying the plurality of modules to a current visual unit of the visual data based on the precision information; and storing the bitstream in a non-transitory computer-readable recording medium.

### Example Device

FIG. 9 illustrates a block diagram of a computing device 900 in which various embodiments of the present disclosure can be implemented. The computing device 900 may be implemented as or included in the source device 110 (or the data encoder 114) or the destination device 120 (or the data decoder 124).

It would be appreciated that the computing device 900 shown in FIG. 9 is merely for purpose of illustration, without suggesting any limitation to the functions and scopes of the embodiments of the present disclosure in any manner.

As shown in FIG. 9, the computing device 900 includes a general-purpose computing device 900. The computing device 900 may at least comprise one or more processors or processing units 910, a memory 920, a storage unit 930, one or more communication units 940, one or more input devices 950, and one or more output devices 960.

In some embodiments, the computing device 900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof.

It would be contemplated that the computing device 900 can support any type of interface to a user (such as “wearable” circuitry and the like).

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem and the like) enabling the computing device 900 to communicate with one or more other computing devices, if required. Such communication can be performed via input/output (I/O) interfaces (not shown).

In some embodiments, instead of being integrated in a single device, some or all components of the computing device 900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 900 may be used to implement visual data encoding/decoding in embodiments of the present disclosure. The memory 920 may include one or more visual data coding modules 925 having one or more program instructions. These modules are accessible and executable by the processing unit 910 to perform the functionalities of the various embodiments described herein.

In the example embodiments of performing visual data encoding, the input device 950 may receive visual data as an input 970 to be encoded. The visual data may be processed, for example, by the visual data coding module 925, to generate an encoded bitstream. The encoded bitstream may be provided via the output device 960 as an output 980.

In the example embodiments of performing visual data decoding, the input device 950 may receive an encoded bitstream as the input 970. The encoded bitstream may be processed, for example, by the visual data coding module 925, to generate decoded visual data. The decoded visual data may be provided via the output device 960 as the output 980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

We claim:

1. A method for visual data processing, comprising:
determining, for a conversion between a current visual unit of visual data and a bitstream of the visual data, precision information indicating at least one precision level for a plurality of modules, at least one of the plurality of modules being based on a neural network model; and
performing the conversion by applying the plurality of modules to the current visual unit based on the precision information.

2. The method of claim 1, wherein the precision information is determined based on a plurality of syntax elements in the bitstream, a syntax element of the plurality of syntax elements indicating a precision level for at least one module of the plurality of modules,
wherein the plurality of precision levels comprises at least one of: int8, int16, int32, int64, float8, float16, float32, float64, or a further precision level.

3. The method of claim 2, further comprising:
determining a precision level from the plurality of precision levels for a first module of the plurality of modules based on a functionality of the first module,
wherein the functionality of the first module comprises one of: an inference functionality, a synthesis functionality, an entropy coding functionality, or a quantization functionality, and/or
wherein a first precision level from the plurality of precision levels is associated with a first functionality, and a second precision level from the plurality of precision levels is associated with a second functionality.

4. The method of claim 2, further comprising:
determining a precision level from the plurality of precision levels for a first module of the plurality of modules based on an operation type of the first module,
wherein the operation type of the first module comprises one of: a convolutional operation, or an activation operation.

5. The method of claim 1, wherein the precision information is based on a single syntax element in the bitstream, the single syntax element indicating a single precision level for the plurality of modules,
wherein the single precision level comprises one of: int8, int16, int32, int64, float8, float16, float32, float64, or a further precision level.

6. The method of claim 1, wherein the at least one precision level is determined based on a result of at least one testing compression of the visual data,
wherein the result comprises at least one of: a compression ratio of the visual data, a maximum memory during the at least one testing compression, or a multiply-accumulate operation.

7. The method of claim 1, wherein the at least one precision level is determined based on a neural architecture search.

8. The method of claim 1, wherein the at least one precision level is determined based on a characteristic of a scenario of the visual data,
wherein the characteristic comprises at least one of: a resolution of the visual data, a bit-depth of the visual data, or a content of the visual data,
wherein the content of the visual data comprises at least one of: a surveillance content, a screen content, or a natural scene.

9. The method of claim 1, wherein the visual data comprises an image or a video, and the current visual unit comprises one of: a tile, the image, or an image in the video.

10. The method of claim 1, wherein the precision information is compressed with an entropy coding tool, or
wherein the precision information is determined based on further precision information of a further visual unit previously coded, or
wherein a mixed precision determination is performed during the conversion.

11. The method of claim 1, wherein the precision information is stored in at least one of:
a profile associated with the visual data, or
a level setting associated with the visual data.

12. The method of claim 1, wherein a first operation is adjacent to a second operation during the conversion, the first operation being associated with a first precision level, the second operation being associated with a second precision level different from the first precision level, and
wherein performing the conversion comprises:
performing the first operation to a first representation associated with the visual data to obtain a second representation;
performing at least one of a quantization operation or an inverse quantization operation to the second representation to obtain a third representation; and
performing the second operation to the third representation.

13. The method of claim 12, wherein at least one of a first parameter of the quantization operation or a second parameter of the inverse quantization operation is determined based on a training dataset, or
wherein at least one of a first parameter of the quantization operation or a second parameter of the inverse quantization operation is included in the bitstream, wherein at least one of the first parameter or the second parameter is determined by an encoder for encoding the current visual unit into the bitstream.

14. The method of claim 1, wherein the conversion comprises decoding the current visual unit from the bitstream.

15. The method of claim 14, wherein the plurality of modules at least comprises an entropy module, a decoding module and a synthesis module, the precision information is obtained from at least one syntax element in the bitstream, and
wherein performing the conversion comprises:
determining respective precision levels of the plurality of modules based on the precision information;
initializing the plurality of modules based on the respective precision levels;
determining a first representation of the current visual unit based on the bitstream by using the entropy module;
determining a second representation of the current visual unit based on the first representation by using the decoding module; and
determining a reconstruction of the current visual unit based on the second representation by using the synthesis module.

16. The method of claim 1, wherein the conversion comprises encoding the current visual unit into the bitstream.

17. The method of claim 16, further comprising:
determining at least one precision level for the plurality of modules based on at least one of: operation types of the plurality of modules, functionalities of the plurality of modules, a result of at least one testing compression of the visual data, a neural architecture search, or a characteristic of a scenario of the visual data;
determining a first representation of the at least one precision level based on an analysis transform;
determining a second representation of the at least one precision level based on the first representation by using at least one of a scaling operation or a rounding operation;
determining at least one syntax element for the precision information based on the second representation and an entropy coding module; and
including the at least one syntax element in the bitstream.

18. An apparatus for visual data processing comprising a processor and a non-transitory memory with instructions thereon, wherein the instructions upon execution by the processor, cause the processor to:
determine, for a conversion between a current visual unit of visual data and a bitstream of the visual data, precision information indicating at least one precise level for a plurality of modules, at least one of the plurality of modules being based on a neural network model; and
perform the conversion by applying the plurality of modules to the current visual unit based on the precision information.

19. A non-transitory computer-readable storage medium storing instructions that cause a processor to perform a method comprising:
determining, for a conversion between a current visual unit of visual data and a bitstream of the visual data, precision information indicating at least one precise level for a plurality of modules, at least one of the plurality of modules being based on a neural network model; and
performing the conversion by applying the plurality of modules to the current visual unit based on the precision information.

20. A non-transitory computer-readable recording medium storing a bitstream of visual data which is generated by a method performed by an apparatus for visual data processing, wherein the method comprises:
determining precision information indicating at least one precise level for a plurality of modules, at least one of the plurality of modules being based on a neural network model; and
generating the bitstream by applying the plurality of modules to a current visual unit of the visual data based on the precision information.
